(19) United States
(12) Patent Application Publication
(10) Pub. No.: US 2024/0375169 A1
(43) Pub. Date: Nov. 14, 2024

(54) WORK HEAD FOR A COMPRESSION TOOL

(71) Applicant: CEMBRE S.P.A., Brescia (IT)

(72) Inventors: Cesare BRAGA, Brescia (IT); Davide NICOLAI, Brescia (IT)

(21) Appl. No.: 18/659,778

(22) Filed: May 9, 2024

(30) Foreign Application Priority Data
May 11, 2023 (IT) 102023000009483

(51) Int. Cl. B21D 39/04

(52) U.S. Cl. CPC B21D 39/048

(57) ABSTRACT

A work head for or of a compression tool includes a compression jaw and an abutment jaw forming an arched abutment surface having a longitudinal extension arched in a hypothetical arc plane orthogonal to an insertion direction of the object into the abutment seat. The longitudinal extension has a first side segment, a second side segment opposite to the first side segment, and an apex segment in the shape of a neck extending between the first side segment and the second side segment, and an abutment width measurable in the insertion direction and orthogonal to the arc plane. The abutment width decreases from a first base width of the first side segment to an apex width of the apex segment. The abutment width decreases from a second base width of the second side segment to the apex width of the apex segment.

### CROSS-REFERENCE TO RELATED APPLICATIONS

The present application claims priority to Italian Patent Application No. 102023000009483 filed on May 11, 2023, which application is incorporated herein by reference in its entirety.

### FIELD OF THE INVENTION

The present invention relates to a work head for a compression tool (e.g., a hydrodynamic compression tool).

### SUMMARY

Motor-driven compression or crimping tools are often used to perform specific connection operations, e.g., the compression of connectors about electrical cables, the compression of hydraulic connectors, or the compression of rivets.

Such tools usually comprise an electric motor powered by an accumulator, and in the case of hydrodynamic tools, a hydraulic pump actuated by the electric motor and a cylinder-piston assembly, to move a compression jaw (e.g., punch-shaped) towards a fixed jaw of the tool. The jaws can be shaped (dieless jaws) and/or provided with interchangeable accessory elements (jaws with dies) so as to adapt to a particular product, e.g., an electrical contact, in particular a terminal to be crimped.

Since compression tools are used to compress objects of different sizes (diameters), in the case of dieless tools and in the case of universal compression dies, the shape of the abutment seat of the abutment jaw (typically a fixed jaw) is not always compatible with the outer shape of the object to be compressed (as it can be seen in FIGS. 4,5,6, for example).

With reference to the diameter of the object to be compressed, for at least some object sizes, the initial contact between the abutment seat and the object will occur along one or more contact lines and not along large two-dimensional or three-dimensional surfaces.

With reference to the length of the object to be compressed and the length of the compression zone, it should be noted that objects (for example the tubular part, the so-called barrel of a terminal) with larger diameters typically also have a greater length than objects with a small diameter.

In order to perform the compression over the whole length also required for large objects, without needing to carry out more than one compression operation, in the prior art, the thickness of the abutment seat of the abutment jaw (typically a fixed jaw) is dimensioned for the expected largest object size.

This results in the disadvantage that, when objects with small diameter and length are compressed, the very large thickness of the abutment jaw of the tool covers the object from the user's view, hindering the correct positioning thereof in the abutment seat. In the case of terminals consisting of a tubular portion to be crimped about an electrical cable and a flattened, enlarged portion with respect to the tubular portion (FIGS. 14, 15), the “oversized” thickness of the abutment jaw can also cause a violation of space with the enlarged portion of the terminal and prevent a centered positioning thereof with respect to the compression jaw, which is typically configured as a pointed punch.

With reference to the actual compression operation and to the necessary compression force, in the prior art the abutment jaw (or fixed jaw) is shaped with a simple curvature, that is:
linear in an axial direction of the object to be compressed, and
concave and curved, e.g., in an arc-of-a-circle or “V” shape with a rounded apex, in a transverse direction of the object to be compressed.

On the other hand, the compression jaw or punch is cone-shaped with a rounded tip or cone-shaped with circular steps.

The final maximum compression force applied and the shape of the compression impression made in the object results in the electrical contact and/or mechanical resistance obtained (e.g., resistance against the removal of the cable from the terminal).

The energy needed to perform the compression is given by the integral of the instantaneous force on the compression stroke. In order to reduce the energy consumption of the tool and increase the autonomy thereof in terms of numbers of compressions on battery charging, it would thus be desirable to obtain a compression force curve which is not close to the maximum compression force value along most of the jaw stroke, but which increases, for example only in the final compression step, from a low force value to the maximum compression force value.

In order to reduce the energy consumption of the tool, it is also desirable or conceivable to obtain the same mechanical resistance of the compressed object (for example the same resistance against the removal of the electrical cable from the terminal) by means of a lower compression force, e.g., by studying new and more advantageous geometric shapes of the impression made on the compressed object.

Therefore, it is the object of the present invention to provide a compression tool without dies (dieless compression tool) or jaws or dies for compression tools having an abutment seat and/or a punch (compression jaw) such as to obviate at least some of the drawbacks of the prior art.

It is a particular object of the invention to provide a compression tool or jaws or dies for compression tools having an abutment seat and/or a punch (compression jaw) such as to facilitate a correct positioning and visibility of objects of different size in the abutment seat.

It is a further object of the invention to provide a compression tool or jaws or dies for compression tools having an abutment seat and/or a punch (compression jaw) such as to make a new and advantageous compression impression in the object with reference to the instantaneous force applied to the object depending on the compression stroke for improved use of the electricity of the tool battery.

It is a further object of the invention to provide a compression tool or jaws or dies for compression tools having an abutment seat and/or a punch (compression jaw) such as to make a new and advantageous compression impression in the object with reference to the impression shape and mechanical resistance of the compressed object, in particular of an electrical contact (terminal) crimped on an electrical cable.

According to an aspect of the invention, at least some of the objectives are achieved by a work head (1) for or of a compression tool (2), comprising:
an abutment jaw (3) forming an abutment seat (4) for receiving an object (5) to be compressed, and
a compression jaw (6), movable with respect to the abutment jaw (3), to perform the compression of the object (5) positioned in the abutment seat (4) between the abutment jaw (3) and the compression jaw (6),
wherein the abutment seat (4) forms an arched abutment surface (7) having:
a longitudinal extension (8) arched in a hypothetical arc plane (9) orthogonal to an insertion direction (10) of the object (5) into the abutment seat (4), wherein the longitudinal extension (8) has a first side segment (11), a second side segment (12) opposite to the first side segment (11), and an apex segment (13) in the shape of a neck extending between the first side segment (11) and the second side segment (12),
an abutment width (14) measurable in the insertion direction (10) and orthogonal to the arc plane (9),
wherein the abutment width (14) decreases from a first base width (15) of the first side segment (11) to an apex width (16) of the apex segment (13) and wherein the abutment width (14) decreases from a second base width (17) of the second side segment (12) to the apex width (16) of the apex segment (13).

According to a further aspect of the invention, at least some of the objectives are achieved by a work head (1) for or of a compression tool (2), comprising:
an abutment jaw (3) forming an abutment seat (4) for accommodating an object (5) to be compressed, and
a compression jaw (6), movable with respect to the abutment jaw (3), to perform the compression of the object (5) positioned in the abutment seat (4) between the abutment jaw (3) and the compression jaw (6),
where the compression jaw (6) forms a punch surface (25) having:
a base (26) at a hypothetical base plane (27),
a convex central apex portion (28) protruding with respect to the base plane (27) along a compression axis (22) orthogonal to the base plane (27),
a lateral portion (29), joined to the central apex portion (28) and extending from the central apex portion (28) to the base (26), diametrically widening with respect to the compression axis (22),
wherein the lateral portion (29) has a plurality of recesses (30) arranged in a circumferential sequence with respect to the compression axis (22) and having:
a longitudinal extension (31) along a direction from the central apex portion (28) to the base (26),
a width (32) transverse to the longitudinal extension (31) in a circumferential direction with respect to the compression axis (22), and
a depth (33) with respect to an outer development profile (34) of the lateral portion (29),
and wherein the recesses (30) are interspersed by protruding ridges (35) having a ridge width (38), measured in the circumferential direction with respect to the compression axis (22), which increases towards the base (26) and decreases towards the central apex portion (28).

### BRIEF DESCRIPTION OF THE DRAWINGS

In order to better understand the invention and appreciate the advantages thereof, a description of non-limiting exemplary embodiments is provided below, with reference to the accompanying drawings, in which:

FIG. 1 is a perspective view of a hydrodynamic compression tool according to an embodiment;

FIG. 2 is a further perspective view of the compression tool in FIG. 1;

FIG. 3 is a longitudinal section view of the hydrodynamic compression tool in FIG. 1;

FIG. 4 shows a work head of the compression tool in FIG. 3 with a compression jaw in a compression start position (first pressing contact with the object to be compressed), and with a very small object to be compressed positioned in an abutment jaw of the work head,

FIG. 5 shows a work head of the compression tool in FIG. 3 with the compression jaw in a compression start position with a medium-sized object to be compressed positioned in the abutment jaw,

FIG. 6 shows a work head of the compression tool in FIG. 3 with the compression jaw in a compression start position with a very large object to be compressed positioned in the abutment jaw,

FIG. 7 is a sectional view of a work head of a compression tool according to an embodiment of the invention, showing the profile of an abutment seat of the abutment jaw,

FIG. 7A is a view of an abutment surface or abutment seat of the abutment jaw having a width varying in a span direction 36 and in an insertion direction 10 of an object, according to an embodiment,

FIG. 8 is a perspective and partial section view of a work head of a compression tool according to an embodiment of the invention, showing the profile of an abutment seat of the abutment jaw and the profile of a compression surface of the compression jaw, as well as the positioning of a large electrical connector in the abutment seat,

FIG. 9 is a perspective and partial section view of the work head in FIG. 8 with a small electrical connector,

FIG. 10 is a side view of a compression jaw (e.g., a movable jaw, a dieless jaw or a die) of a work head of or for a compression tool according to an embodiment,

FIG. 11 is a top view of the compression jaw in FIG. 10,

FIG. 12 is a sectional view of the compression jaw in FIG. 10 according to a section plane XII-XII which is radial to a central axis of the compression jaw,

FIG. 13 is a sectional view of the compression jaw in FIG. 10 according to a section plane XIII-XIII which is orthogonal to a central axis of the compression jaw,

FIG. 14 shows a compressed object (terminal crimped on an electrical cable) with a compression impression obtained by means of the compression jaw in FIG. 10,

FIG. 15 shows a compressed object (terminal crimped on an electrical cable) with a double trapezoidal impression obtained by means of the abutment jaw in FIG. 7,

FIG. 16 is a perspective view of a connection region (in the disassembled configuration) between a piston and a compression jaw of a compression tool according to an embodiment,

FIG. 17 is a perspective view of the connection region in FIG. 16 in the assembled configuration,

FIG. 18 illustrates the operation of assembling and disassembling the connection between the piston and the compression jaw in FIG. 17.

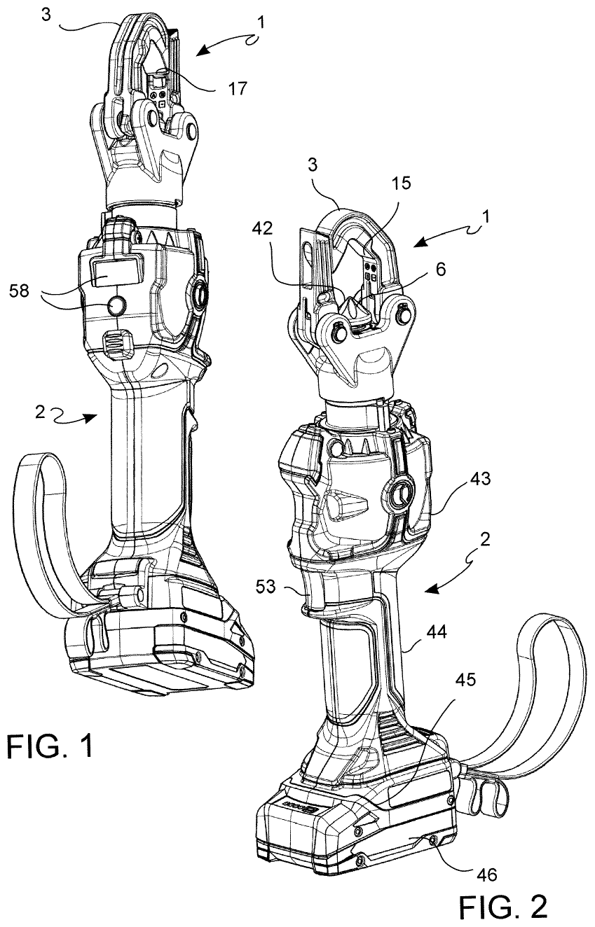

With reference to the figures, a work head 1 for or of a compression tool 2 comprises an abutment jaw 3 forming an abutment seat 4 for receiving an object 5 to be compressed, and a compression jaw 6 movable with respect to the abutment jaw 3 to compress the object 5 positioned in the abutment seat 4 between the abutment jaw 3 and the compression jaw 6.

### DESCRIPTION OF THE ABUTMENT SEAT

The abutment seat 4 forms an arched abutment surface 7 having:
a longitudinal extension 8 arched in a hypothetical arc plane 9 orthogonal to an insertion direction 10 of the object 5 into the abutment seat 4, wherein the longitudinal extension 8 has a first side segment 11, a second side segment 12 opposite to the first side segment 11, and an apex segment 13 in the shape of a neck extending between the first side segment 11 and the second side segment 12,
an abutment width 14 measurable in the insertion direction 10 of the object and orthogonal to the arc plane 9,
wherein the abutment width 14 decreases from a first base width 15 of the first side segment 11 to an apex width 16 of the apex segment 13 and where the abutment width 14 decreases from a second base width 17 of the second side segment 12 to the apex width 16 of the apex segment 13.

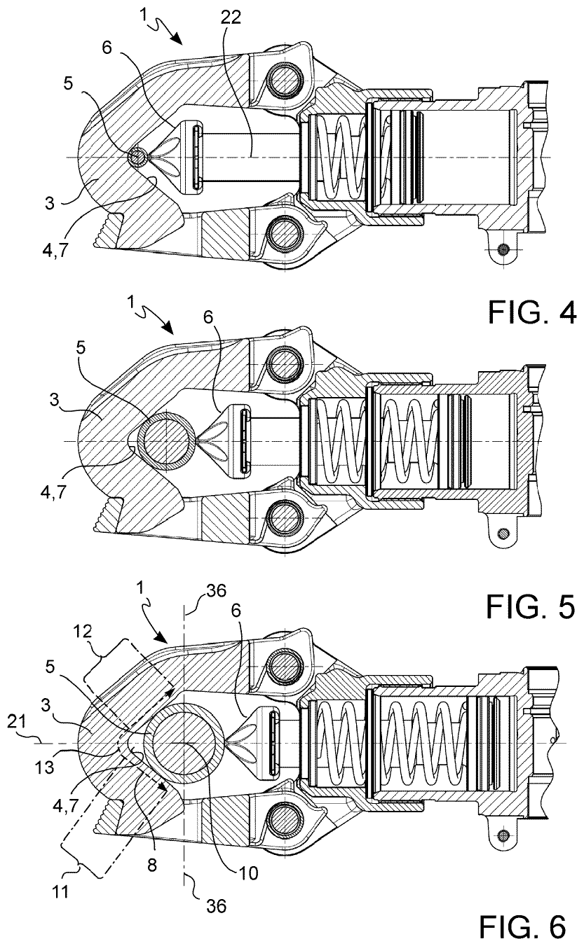

By virtue of the abutment width 14 of the abutment surface 7 decreasing towards the neck-shaped apex segment 13, the objects 5 with a very small diameter are accommodated in the abutment seat 4 and placed against the abutment surface 7 where it has a reduced width and, thus, they are not covered from the user's sight during the positioning (FIGS. 4, 9).

Moreover, again by virtue of the reduced abutment width 14 of the abutment seat 4 in the neck-shaped apex segment 13, the small objects (e.g., a terminal with small diameter and length) can be inserted in a centered position with respect to the axis of the compression jaw (punch) 2 without a violation of space with the thickness of the abutment jaw 3. This facilitates the correct positioning of small objects 5 in the abutment seat 4 of the work head 1 of the compression tool 2 (FIGS. 4, 9).

On the other hand, by virtue of the increased abutment width 14 of the abutment seat 4 away from the neck-shaped apex segment 13 towards the bases of the first side segment 11 and the second side segment 12 (which form the bases of the arc shape of the abutment surface 7), larger objects 5 (e.g., a terminal) are accommodated in the abutment seat 4 and placed against the abutment surface 7 where it has a greater width (base width 14, 15), ensuring a greater extension of the compressed area, e.g., a greater compression length of a tubular portion of a terminal (FIGS. 6, 8).

This new and advantageous configuration of the abutment seat 4 conciliates the needs of:
providing a (dieless) abutment jaw or a universal abutment die, suitable for objects of different sizes, and
a simpler positioning of small objects with greater visibility and without centering obstacles,
a sufficient compression length for larger objects.

According to an embodiment, the first side segment 11 and the second side segment 12 are mutually inclined (in a sectional view in the arc plane 9), so that, at the first 11 and second 12 opposite side segments and moving away from the apex segment 13, the abutment seat 4 (as well as the abutment surface 7) widens in both the insertion direction 10 (due to the increase in the abutment width 14) and the span direction 36 (perpendicular to the insertion direction 10 and lying in the arc plane 9) of the arc, obtaining the desired effect of an increased compression area (width) as the diameter of the object 5 increases.

According to an embodiment, the abutment seat 4 or abutment surface 7 has an arched “V” shape, in which the first side segment 11 and the second side segment 12 are substantially rectilinear (in a sectional view in the arc plane 9).

Alternatively, the abutment seat 4 or abutment surface 7 has a continuously curved arched shape in a sectional view in the arc plane 9.

Advantageously, the neck-shaped apex segment 13 is arched without corners, e.g., in the shape of an arc of a circle or in the shape of a catenary, and is joined, possibly without corners or steps, to the first side segment 11 and to the second side segment 12. This prevents the generation of incision effects and reduces concentrations of mechanical tensions in the abutment jaw 3.

In order to ensure an abutting placement of the object 5 against the abutment seat 4, which is completely or at least mainly perpendicular to the insertion direction 10 (corresponding, for example, to an axial direction of the crimpable portion of a terminal), it is advantageous to make the abutment surface 7 with a simple curvature only in the arc plane 9 and rectilinear in the insertion direction 10.

The abutment surface 7 is thus shaped like a web or strip having a width that, in the insertion direction 10, is gradually tapered from the two opposite base ends of the side segments 11, 12 towards the central apex segment 13.

At the first side segment 11 and the second side segment 12, the abutment surface 7 is trapezoidal with the minor base at the apex segment 13. This makes two abutment impressions 18 in the object 5 (FIG. 15), mutually spaced apart and tapered towards each other, which have proven to be advantageous in terms of mechanical resistance of crimped electrical connectors.

The reduction in abutment width 14 in and towards the apex segment 13 can be obtained by a reduction in the thickness of the whole abutment jaw 3 or advantageously by a localized reduction in the thickness of the abutment jaw 3 in a radial direction from an abutment jaw extrados 19 towards an intrados thereof forming the abutment seat 4.

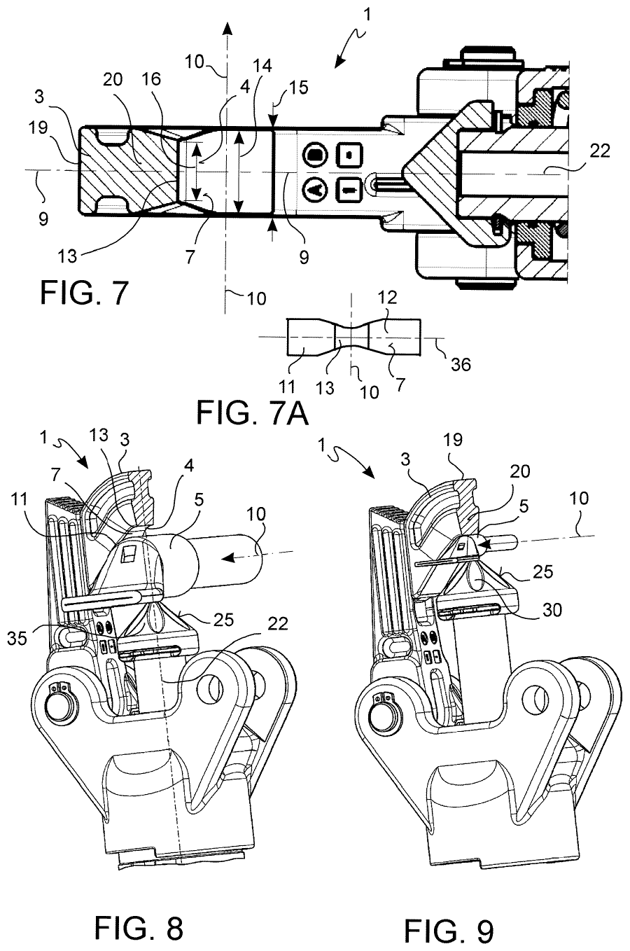

At the apex segment 13, the abutment surface 7 (as well as the abutment seat 4) is thus formed by a shorter base of an abutment portion 19 of the abutment jaw 3 having a trapezoidal section (FIG. 7). Such a trapezoidal section shape is particularly advantageous for applying the compression force to the object 5.

The abutment seat 4 (as well as the abutment surface 7) is advantageously symmetrical to a plane of symmetry 21 orthogonal to the arc plane 9 and parallel to a compression axis 22 oriented in the movement direction of the compression jaw 6 with respect to the abutment jaw 3.

The abutment seat 4 can be made in one piece with a base body 24 of the abutment jaw 3, without the presence of a replaceable abutment die, thus obtaining a dieless abutment jaw 3.

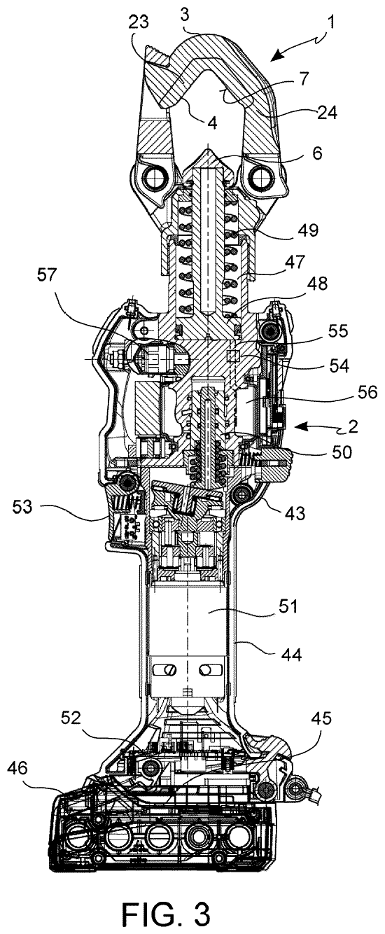

Alternatively, the abutment seat 4 can be formed by an abutment die 23 (FIG. 3) applied in a replaceable manner to a base body 24 of the abutment jaw 3.

### DESCRIPTION OF THE PUNCH SURFACE

The compression jaw 6 forms a punch surface 25 having a base 26 at a hypothetical base plane 27, a convex central apex portion 28 (the tip of the punch) protruding with respect to the base plane 27 along a compression axis 22 orthogonal to the base plane 27, a lateral portion 29, joined to the central apex portion 28 and extending from the central apex portion 28 to the base 26, extending diametrically with respect to the compression axis 22.

The lateral portion 29 has a plurality of recesses 30 arranged in a circumferential sequence with respect to the compression axis 22 and having a longitudinal extension 31 along a direction from the central apex portion 28 towards the base 26, a width 32 transverse to the longitudinal extension 31 in a circumferential direction with respect to the compression axis 22, and a depth 33 with respect to an outer development profile 34 of the lateral surface portion 29.

The recesses 30 are interspersed (or separated from one another) by ridges (35) protruding with respect to a bottom 37 of the recesses 30 and having a ridge width 38, in the circumferential direction with respect to the compression axis 22, which increases towards the base 26 and decreases towards the central apex portion 28.

The particular configuration of the punch surface 25 achieves a minimization or reduction in the contact area and a greater concentration of local pressure in an initial step of compression of (or penetration in) the object. In fact, by virtue of the presence of the recesses, after penetration of the central apex portion 28 (the punch tip) in the object 5 to be compressed, a pressure contact on the whole circumference of the lateral surface portion 29 does not occur immediately, but only at the protruding ridges 35, while the bottom 37 of the recesses 30 does not engage the object yet.

In a next advancement step of the compression jaw 6 along the compression axis 22, the pressures applied to the object 5 are still concentrated on the central apex portion 28 and along the ridges 35, allowing a further penetration of the punch surface 25 in the object 5, using a relatively low compression force, as well as a circumferentially wavy shape of a compression impression 39 in the object 5 (FIGS. 13, 14). This circumferentially wavy impression shape increases the total impression surface and improves the mechanical resistance (and the electrical contact connection) of the compressed object.

In a further or final compression step, the contact area of the ridges 35 widens, and by virtue of the gradual penetration of the punch surface 25 in the object, the bottoms 37 of the recesses 30 also increasingly take part in the compression and deformation of the object 5. It is mainly in this last step that the total compression force quickly rises from a relatively moderate value to the maximum force value. Accordingly, the maximum mechanical stresses of the compression tool 2 and the maximum electric power absorption only concern a reduced phase of the work cycle. The electricity needed to complete the compression is thus used more efficiently compared to the prior art and the mechanical stresses and wear of the tool 2 are also reduced.

According to an embodiment, the recesses 30 have a substantially oval or elliptical or elongated-petal shape, with a star or spoke orientation in a top view in the direction of the compression axis 22 (FIG. 11).

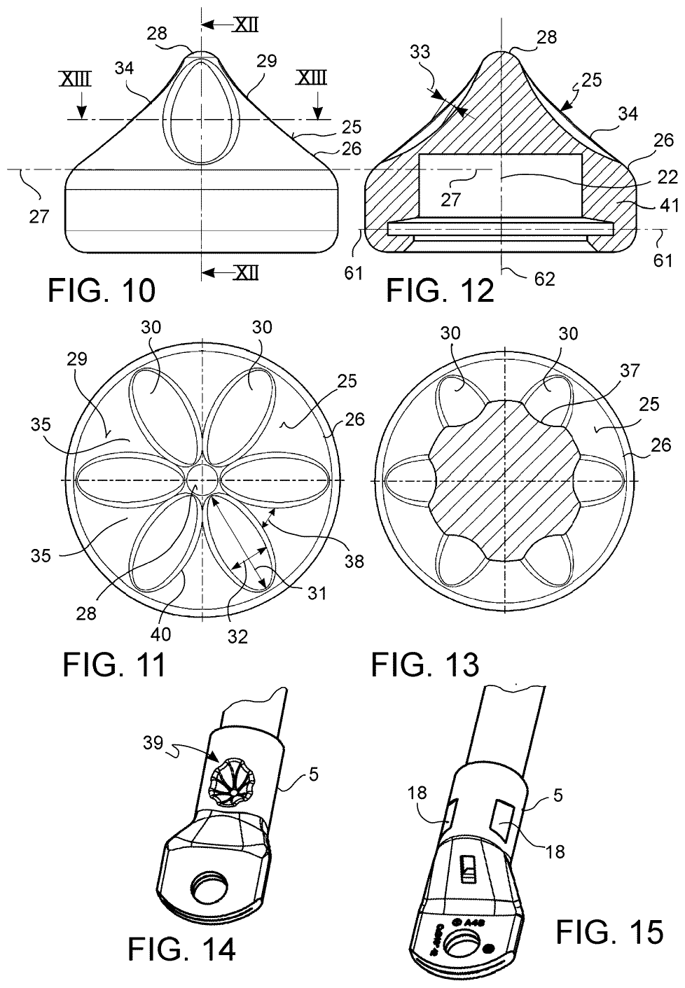

According to an embodiment, the width 32 of the recesses 30 is maximum in a central quarter or half of the longitudinal extension 31 thereof and gradually decreases towards both the central apex portion 28 and the base 26 (FIGS. 10, 11).

The recesses are delimited by a peripheral edge 40 and the bottom 37 is concave and curved in both the direction of longitudinal extension 31 and the circumferential direction with respect to the compression axis 22.

The maximum depth 33 of the recesses 30 is in the range from 1/5 to 1/150, preferably in the range from 1/7 to 1/10, of the longitudinal extension 31 thereof.

The ridges 35 are laterally delimited by peripheral edges 40 of the recesses 30 and have a tapered or converging cusp shape towards the central apex portion 28, in a top view in the direction of the compression axis 22 (FIG. 11).

Advantageously, the outer development profile 34 of the lateral surface portion 29 is frustoconical or hyperbolic.

The outer development profile 34 can be rotary symmetrical (except for the recesses 30). The recesses 30 can all have the same shape and can be positioned at a constant circumferential pitch, with an odd or even number, e.g., six recesses 30.

Advantageously, the punch surface 25 is symmetrical to a plurality of radial planes with respect to the compression axis 22.

The compression impression 39 obtainable by means of the punch surface 25 is a circumferentially wavy cavity converging towards a central point-shaped bottom from which petal-shaped radial impressions extend (FIG. 14)

The punch surface 25 can be directly formed by a main body 41 of the compression jaw 6, without the presence of a replaceable abutment die, thus obtaining a dieless compression jaw 6.

Alternatively, the punch surface 25 can be formed by a compression die 42 (FIG. 2) applied in a replaceable manner to a main body 41 of the compression jaw 6.

The compression axis 22 is preferably oriented in a centered manner with respect to the apex segment 13 of the abutment seat 4 of the abutment jaw 3.

Detailed description of the compression tool 2

The hydrodynamic compression tool 2 comprises a housing 43 with a central grip-shaped portion 44 and a coupling portion 45 for the connection, preferably snappingly, of a replaceable and rechargeable electric battery 46 at the rear end of the tool 2.

The compression tool 2 comprises the work head 1 connected to the housing 43.

The compression tool 2 further comprises a hydraulic cylinder 47 and a piston 48 accommodated in the hydraulic cylinder 47, as well as a return spring 49 which elastically biases the piston 48 in a stroke start position with respect to the hydraulic cylinder 47. The piston 48 is connected to the compression jaw 6 and can translate with respect to the hydraulic cylinder 47.

The compression tool 2 further comprises a hydraulic pump 50 with an electric motor 51 powerable by the battery 46 through a power supply and control circuit 52 having a switch on which a manual operation button 53 acts, arranged adjacent to the grip 44. The hydraulic pump 50 is actuatable to increase the pressure of a hydraulic fluid acting in the hydraulic cylinder 47 on the piston 48 so as to move the piston 48 from the stroke start position to a stroke end position and thus move the compression jaw 6 towards the abutment jaw 3.

A maximum pressure valve 54 is arranged in a hydraulic fluid return duct 55 which connects the hydraulic cylinder 47 to a tank 56 of the hydraulic pump 50.

The hydraulic pump 50 thus pumps the hydraulic fluid from the tank 56 into the hydraulic cylinder 47 to cause the piston 48 along with the compression jaw 6 to advance until reaching, in the hydraulic cylinder 47, a predetermined maximum pressure of the hydraulic fluid or until the electric motor 51 switches off. Upon reaching the maximum pressure, the maximum pressure valve 54 (safety valve) automatically opens the return duct 55 to discharge the pressure fluid from the hydraulic cylinder 47 into the tank 56.

The compression tool 2 can comprise a pressure sensor 57 positioned and configured to detect a pressure of the hydraulic fluid acting on the piston 48, as well as an electronic control circuit 52 in signal connection with the pressure sensor 57 and the electric motor 51.

The electronic control circuit 52 is configured to control the electric motor 51 depending on the pressure signals of the pressure sensor 57.

The tool 1 comprises a user interface 58 with a display connected to the electronic control circuit 52, which is configured to cause, by means of such a user interface 58, a display and selection of operating parameters of the compression tool 1.

According to an embodiment, the invention also relates to a reversible mechanical connection 59 between a first component 6 and a second component 48, advantageously implementable in the work head 1, in particular for the connection of the compression jaw 6 (first component 6) with the piston 48 (second component 48).

In the prior art, the connections between piston and jaw have been made by means of: a connection screw (undesirably increasing the volume of the connection region and the assembly and disassembly time due to the screwing and unscrewing operations), or a connection pin (with the known difficulties of removing the pin in the case of maintenance and separation of the connection).

According to an aspect of the invention, the reversible mechanical connection 59 comprises:
a first connection groove 60 extending along a (circular or polygonal) circumference segment of the first component 6 (compression jaw 6) in a connection plane 61 orthogonal to a connection axis 62 and open in a radial direction with respect to the connection axis 62,
a second connection groove 63 extending along a (circular or polygonal) circumference segment of the second component 48 (piston 48) and positioned so as to lie in the same connection plane 61 and to be open in the same radial direction with respect to the connection axis 61 and directly facing the first connection groove 60,
a Seeger ring 64 positioned in an engagement configuration between the first component 6 and the second component 48 and extending in both the first connection groove 60 and the second connection groove 63 so as to prevent the first component 6 from detaching from the second component 48 along the connection axis 62.

The Seeger ring 64 is elastically deformable (e.g., by means of a clamp), in the radial direction with respect to the connection axis 62, from the engagement configuration to a disengagement configuration, in which it releases or disengages one of the first 60 and second 63 connection grooves and engages, more deeply, the other of the first 60 and second 63 connection grooves, to allow a detachment and approaching movement between the first connection groove 60 and the second connection groove 63.

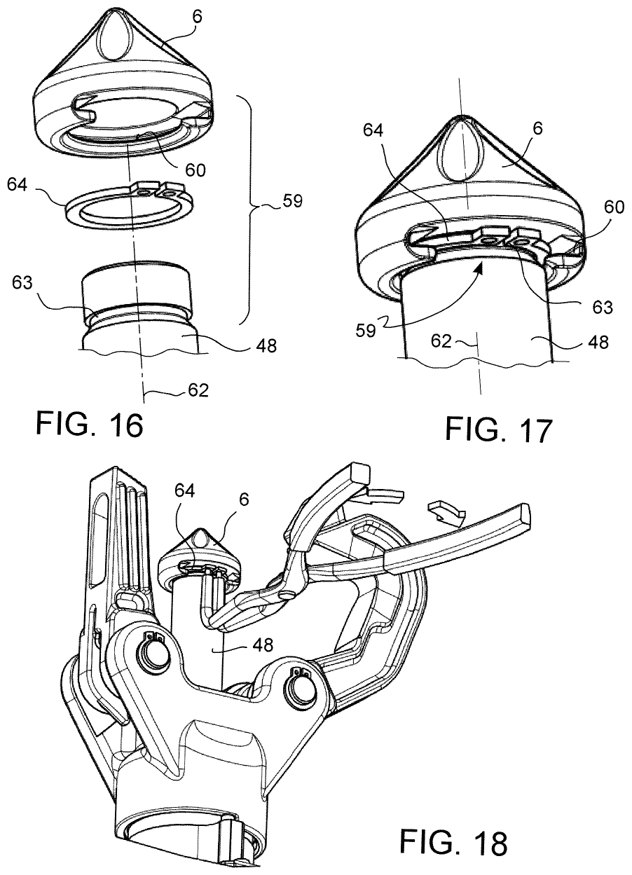

The advantage of the reversible connection 59 is a very small volume and a simpler and quicker connection and disconnection using a clamp for Seeger rings (FIGS. 16, 17, 18).

### LIST OF REFERENCE NUMERALS

work head 1
compression tool 2
abutment jaw 3
abutment seat 4
object 5
compression jaw 6
abutment surface 7
longitudinal extension 8
hypothetical arc plane 9
insertion direction 10
first side segment 11
second side segment 12
neck-shaped apex segment 13
abutment width 14
first base width 15
apex width 16
second base width 17
abutment impressions 18
abutment jaw extrados 19
abutment portion 20
plane of symmetry 21
compression axis 22
abutment die 23
base body 24
punch surface 25
base 26
base plane 27
central apex portion 28
lateral portion 29
recesses 30
longitudinal extension 31
width 32
depth 33
outer development profile 34
ridges 35
span direction 36 of the abutment seat
bottom 37 of the recesses 30
ridge width 38
compression impression 39
peripheral edge 40 of the recesses
main body 41
compression die 42
housing 43
grip 44
battery coupling portion 45
electric battery 46
hydraulic cylinder 47
piston 48
return spring 49
hydraulic pump 50
electric motor 51
control circuit 52
operation button 53
maximum pressure valve 54
return duct 55
tank 56
pressure sensor 57
user interface 58 with a display
reversible mechanical connection 59
first connection groove 60
connection plane 61
connection axis 62
second connection groove 63
Seeger ring 64

1. A work head for or of a compression tool, comprising:
an abutment jaw forming an abutment seat for accommodating an object to be compressed; and
a compression jaw movable with respect to the abutment jaw to perform compression of the object positioned in the abutment seat between the abutment jaw and the compression jaw;
wherein the abutment seat forms an arched abutment surface having:
a longitudinal extension arched in a hypothetical arc plane orthogonal to an insertion direction of the object into the abutment seat, wherein the longitudinal extension has a first side segment, a second side segment opposite to the first side segment, and an apex segment in a shape of a neck extending between the first side segment and the second side segment,
an abutment width measurable in the insertion direction and orthogonal to the arc plane,
wherein the abutment width decreases from a first base width of the first side segment to an apex width of the apex segment, and wherein the abutment width decreases from a second base width of the second side segment to the apex width of the apex segment.

2. A work head according to claim 1, wherein the first side segment and the second side segment are mutually inclined, in a sectional view in the arc plane, so that at the first and second opposite side segments and moving away from the apex segment, the abutment surface enlarges both in the insertion direction and in a span direction.

3. A work head according to claim 1, wherein the abutment seat has an arched “V” shape, wherein the first side segment and the second side segment are rectilinear.

4. A work head according to claim 1, wherein the apex segment in the shape of a neck is arched without corners, or in a shape of an arc of a circle or in a shape of a catenary, and is joined, without corners, to the first side segment and the second side segment.

5. A work head according to claim 1, wherein the abutment surface has a simple curvature only in the arc plane and is rectilinear in the insertion direction.

6. A work head according to claim 1, wherein the abutment surface is strip shaped, a width of which, in the insertion direction, is gradually tapered from two base ends of the side segments towards the central apex segment.

7. A work head according to claim 1, wherein:
at the first side segment and the second side segment, the abutment surface is trapezoidal with a shorter base at the apex segment.

8. A work head according to claim 1, wherein an abutment width reduction in and towards the apex segment comprises a localized thickness reduction of the abutment jaw in a radial direction from an abutment jaw extrados towards an intrados of the abutment jaw forming the abutment seat; and
wherein at the apex segment, the abutment surface is formed by a minor base of an abutment portion of the abutment jaw having a trapezoidal cross-section.

9. A work head according to claim 1, wherein the abutment seat is symmetrical to a plane of symmetry orthogonal to the arc plane and parallel to a compression axis oriented in a movement direction of the compression jaw with respect to the abutment jaw.

10. A work head according to claim 1, wherein the abutment seat is made in one piece with a base body of the abutment jaw, to make a dieless abutment jaw.

11. A work head according to claim 1, wherein the compression jaw forms a punch surface comprising:
a base at a hypothetical base plane;
a convex central apex portion protruding with respect to the base plane along a compression axis orthogonal to the base plane;
a lateral portion, joined to the central apex portion and extending from the central apex portion to the base, widening diametrically with respect to the compression axis;
wherein the lateral portion has a plurality of recesses arranged in a circumferential sequence with respect to the compression axis and having:
a longitudinal extension along a direction from the central apex portion to the base,
a width transverse to the longitudinal extension in a circumferential direction with respect to the compression axis, and
a depth with respect to an outer development profile of the lateral portion, and
wherein the recesses are interspersed by protruding ridges having a ridge width, measured in the circumferential direction with respect to the compression axis, which increases towards the base and decreases towards the central apex portion.

12. A work head according to claim 11, wherein the recesses have a substantially oval or elliptical or elongated-petal shape, with a star or spoke orientation in a top view in a direction of the compression axis.

13. A work head according to claim 11, wherein the width of the recesses is maximum in a central quarter or half of the longitudinal extension of the width recess and decreases towards both the central apex portion and the base.

14. A work head according to claim 11, wherein the recesses are delimited by a peripheral edge and a bottom is concave and curved in both the direction of longitudinal extension and the circumferential direction with respect to the compression axis.

15. A work head according to claim 11, wherein a maximum depth of the recesses is in the range from 1/5 to 1/150 of the longitudinal extension of the recesses.

16. A work head according to claim 11, wherein the ridges are laterally delimited by peripheral edges of the recesses and have a converging cusp shape towards the central apex portion, in a top view in the direction of the compression axis.

17. A work head according to claim 11, wherein the outer development profile of the lateral surface portion is frustoconical or hyperbolic.

18. A work head according to claim 11, wherein all recesses have a same shape and are positioned at a constant circumferential pitch, and
the punch surface is symmetrical with respect to a plurality of radial planes with respect to the compression axis.

19. A work head according to claim 11, wherein the punch surface is formed directly by a main body of the compression jaw, to produce a dieless compression jaw.

20. A work head according to claim 1, wherein:
the abutment surface makes, in the object, two abutment impressions spaced apart from each other and tapered towards each other, or trapezoidal;
the punch surface makes, in the object, a compression impression in a shape of a circumferentially wavy cavity converging towards a central point-shaped bottom from which petal-shaped radial impressions extend.

21. A work head according to claim 1, comprising a reversible mechanical connection between the compression jaw and a piston, wherein the reversible mechanical connection comprises:
a first connection groove extending along a circumference segment of the compression jaw in a connection plane orthogonal to a connection axis and open in a radial direction with respect to the connection axis;
a second connection groove extending along a circumference segment of the piston and positioned to lie in a same connection plane and to be open in a same radial direction with respect to the connection axis and directly facing the first connection groove;
a Seeger ring positioned in an engagement configuration between the compression jaw and the piston and extending in both the first connection groove and the second connection groove to prevent the compression jaw from detaching from the piston along the connection axis;
wherein the Seeger ring is elastically deformable from the engagement configuration to a disengagement configuration in which the Seeger ring releases one of the first and second connection grooves and engages, more deeply, the other of the first and second connection grooves, to allow a detachment and approximation between the first connection groove and the second connection groove.

22. A hydrodynamic compression tool comprising a work head according to claim 1.
